(19) United States
(12) Patent Application Publication
(10) Pub. No.: US 2026/0107080 A1
(43) Pub. Date: Apr. 16, 2026

(54) Wind Noise Reduction Structure for Wireless Bluetooth Earphones

(71) Applicant: Dongguan Hele Electronics Co., Ltd., Dongguan, Guangdong (CN)

(72) Inventors: Shukang CHEN, Dongguan, Guangdong (CN); Shiweng WEI, Dongguan, Guangdong (CN); Fubang XIE, Dongguan, Guangdong (CN)

(21) Appl. No.: 18/857,834

(22) PCT Filed: Apr. 19, 2023
(86) PCT No.: PCT/CN2023/089089

§ 371 Date: Jun. 24, 2025

(30) Foreign Application Priority Data
Apr. 23, 2022 (CN) 202220946380.8

(51) Int. Cl. H04R 1/08; H04R 1/10

(52) U.S. Cl. CPC H04R 1/083; H04R 1/1016; H04R 1/1083; H04R 2201/107; H04R 2410/07; H04R 2420/05

(57) ABSTRACT

A wind noise reduction structure and method for wireless Bluetooth earphones, which includes: an earphone body and a stem connected to the earphone body, wherein a perforation serving as a microphone hole is provided near the lower end of the stem. This perforation passes through the stem, and its opening direction intersects with the axial direction of the stem. External sound enters through the perforation and is transmitted to a microphone located inside the stem. In this invention, the microphone hole is designed as a perforation, and the direction of the perforation is roughly perpendicular to the axial direction of the stem, preventing direct frontal wind from blowing into the microphone hole and causing clipping distortion during sound capture. The perforation has two ports, and the through-structure maximizes the reduction of turbulence effects.

### FIELD OF THE INVENTION

The present invention relates to the field of earphones, particularly to a wind noise reduction structure for wireless Bluetooth earphones.

### BACKGROUND OF THE INVENTION

Currently, the earphone market is seeing an increasing number of wireless Bluetooth earphone products, and many earphones come with active noise cancellation and microphone call functions. As shown in FIG. 1, this is a current wireless Bluetooth earphone, which includes an earphone body 41 and a stem 42. The earphone body 41 is equipped with an earplug 43 for insertion into the human ear canal. The stem 42 typically houses a battery and related circuits. A microphone hole 40 (commonly known as a mic hole) is located at the lower end of the stem to receive the user's voice during a call. The microphone hole 40 adopts a single-hole design and is positioned at the bottom of the stem because, during use, the stem typically hangs at an angle near the human ear, with the microphone hole facing the user's mouth to receive the voice. However, the main problem with this design is that during actual use, especially while walking or cycling, the microphone hole, which faces the user's mouth, is also directly exposed to oncoming wind, causing turbulence in the stem and leading to significant distortion and wind noise, such as a “puffing” sound, during calls. Although wind noise can be reduced using algorithms for digital signal processing, the improvement under this structure is minimal.

Given this issue, the inventor proposes the following technical solution.

### SUMMARY OF THE INVENTION

The technical problem addressed by the present invention is to overcome the deficiencies of existing technology and provide a wind noise reduction structure for wireless Bluetooth earphones.

To solve the above technical problem, the invention adopts the following technical solution:

A wind noise reduction structure for wireless Bluetooth earphones, comprising an earphone body and a stem connected to the earphone body. The stem has a perforation near its lower end, which serves as a microphone hole. This perforation passes through the stem, and its opening direction intersects with the axial direction of the stem. External sound enters through the perforation and is transmitted to a microphone set inside the stem.

Further, in the above technical solution, the perforation includes a left channel, a right channel, and a connecting chamber located between the left and right channels, with the left and right channels connected via the connecting chamber.

Further, in the above technical solution, the connecting chamber has an opening for communicating with the microphone.

Further, in the above technical solution, a mounting platform for installing the microphone is formed at the opening of the chamber.

Further, in the above technical solution, the perforation's opening direction forms an angle of 70°-90° with the axial direction of the stem.

Further, in the above technical solution, the perforation forms a left port and a right port on the surface of the left and right sides of the stem, and the surfaces of the left and right sides of the stem are not parallel.

Further, in the above technical solution, the surface of the stem has a curved surface, and the left and right ports are located on this curved surface.

The stem includes a front stem and a rear stem that engage with each other. The earphone body is fixedly connected to or integrally formed with the front stem, and the perforation passes through the front stem.

After adopting the above technical solution, compared with the prior art, the present invention has the following beneficial effects:

The invention adopts a novel microphone hole structure design, wherein the microphone hole is a perforation, and its direction is roughly perpendicular to the axial direction of the stem. This avoids direct wind blowing into the microphone hole and causing clipping distortion during sound capture. The perforation, with two ports, reduces the impact of turbulence to the greatest extent. With this design, during actual use in windy environments, such as cycling, walking fast, or windy weather, the person on the other end of the call can still hear the user's voice clearly.

### BRIEF DESCRIPTION OF THE DRAWINGS

FIG. 1 is a front view of a current wireless Bluetooth earphone;

FIG. 2 is a perspective view of the present invention;

FIG. 3 is a front view of the present invention;

FIG. 4 is a bottom view of the present invention;

FIG. 5 is an exploded perspective view of the present invention;

FIG. 6 is another perspective view of FIG. 5;

FIG. 7 is a comparative wind noise test curve between the present invention and different earphones;

FIG. 8 is a comparative wind noise test curve between the present invention and the same earphone.

### DETAILED DESCRIPTION OF THE EMBODIMENTS

Below, the invention will be further explained in conjunction with specific embodiments and accompanying drawings.

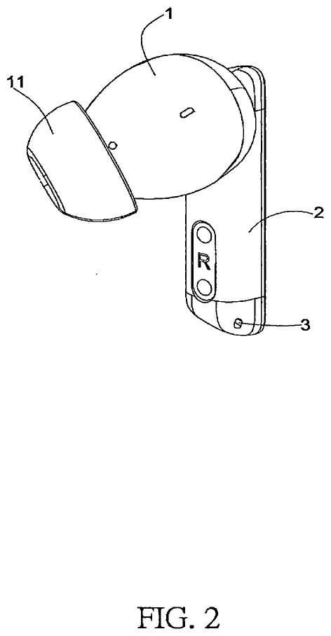

As shown in FIGS. 2 to 6, the present invention is a wind noise reduction structure for wireless Bluetooth earphones, comprising an earphone body 1 and a stem 2 connected to the earphone body 1. A speaker is placed inside the earphone body 1, and when in use, the earphone body 1 is placed near the user's ear canal. Based on actual production, the earphone body 1 may be equipped with an earplug 11 at the sound outlet according to needs.

The stem 2 has a perforation 3 near its lower end, serving as a microphone hole. Since the perforation 3 penetrates the stem 2, it forms a left port 301 and a right port 302 on the left and right surfaces of the stem 2. This perforation design differs entirely from the single-hole structure of current products, and its positioning is also distinct.

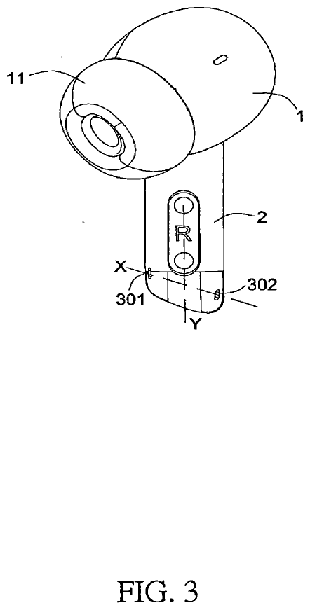

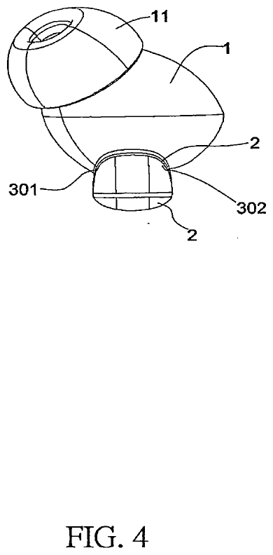

In this embodiment, the left and right surfaces of the stem 2 are non-parallel. More specifically, the surface of the stem 2 has a curved surface 20, with the left port 301 and right port 302 located on this curved surface 20. As shown in FIGS. 3 and 4, due to the curved surface 20 on the stem 2, the left port 301 and right port 302 are inclined towards the front surface of the stem 2, facilitating the transmission of the user's voice to the left port 301 and right port 302.

As shown in FIG. 3, the perforation 3 is oriented in direction X, intersecting with the axial direction Y of the stem 2, forming an angle of 70°-90°, which is nearly vertical. At this time, the left and right ports 301 and 302 are not at the same height, preventing direct wind from blowing into the microphone hole and causing distortion. Moreover, the perforation 3, with its left port 301 and right port 302, and its through structure, minimizes the impact of turbulence.

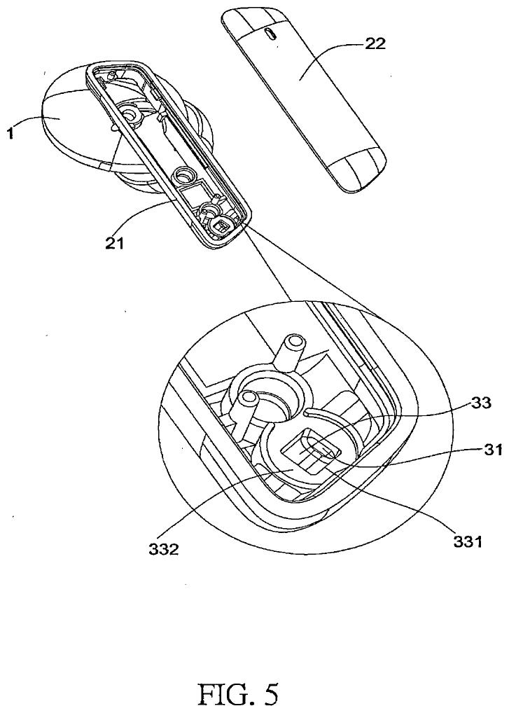

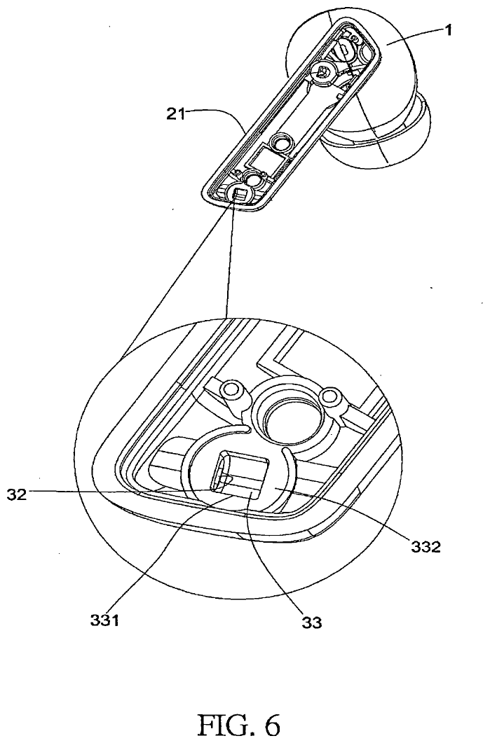

As shown in FIGS. 5 and 6, the stem 2 comprises a front stem 21 and a rear stem 22 that engage with each other. The earphone body 1 is fixedly connected to or integrally formed with the front stem 21, and the perforation 3 is set in the front stem 21, i.e., the perforation 3 passes through the front stem 21. Specifically, the perforation 3 includes a left channel 31 extending from the left port 301 into the front stem 21, a right channel 32 extending from the right port 302 into the front stem 21, and a connecting chamber 33 located between the left and right channels 31 and 32, connecting the left and right channels. Together, they form a through hole.

The connecting chamber 33 has an opening 331 for communicating with the microphone, and a mounting platform 332 for installing the microphone is formed at the opening 331. During assembly, the microphone is mounted on the platform 332, and external sound enters from the left port 301 and right port 302, passes through the left and right channels 31 and 32, and converges in the connecting chamber 33, where it is received by the microphone.

After adopting the above technical solution, the invention has the following beneficial effects compared with prior art:

The invention uses a novel microphone hole design in the form of a perforation. The perforation is oriented roughly perpendicular to the axial direction of the stem, avoiding direct wind from blowing into the microphone hole and causing clipping distortion. With two ports, the through structure minimizes the impact of turbulence. In this design, during windy conditions, especially when cycling, walking fast, or in windy weather, the person on the other end of the call can clearly hear the user's voice.

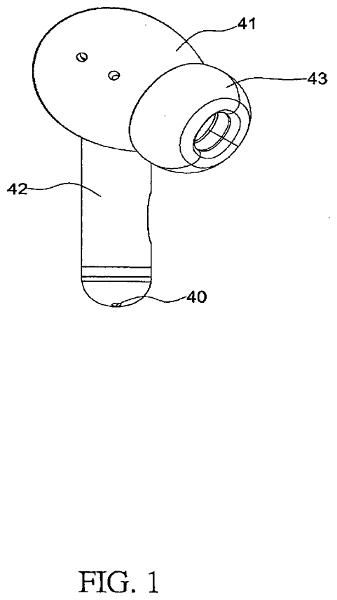

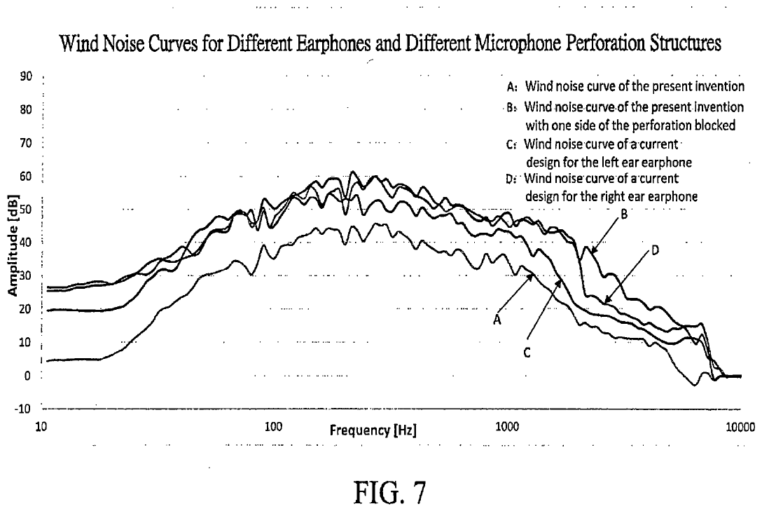

As shown in FIG. 7, this is a wind noise test comparison chart between the invention and the comparative examples. The test products include:
A, an earphone made using the technical solution of the present invention, as shown in FIGS. 2-6;
B, comparative example: a product where one side of the perforation in product A is blocked, i.e., either the left port 301 or the right port 302 is blocked;
C, comparative example: a wireless earphone for the left ear, as shown in FIG. 1;
D, comparative example: a wireless earphone for the right ear, as shown in FIG. 1.

As shown in FIG. 7, after testing and comparison, the wind noise reduction effect of the present invention is significantly better than that of the comparative examples. For example, in comparative product B, although the earphone used the technical solution of the present invention, the wind noise reduction effect was not much different from that of other comparative products due to the blocking of one side of the perforation. This indicates that the through perforation structure plays a major role in reducing wind noise.

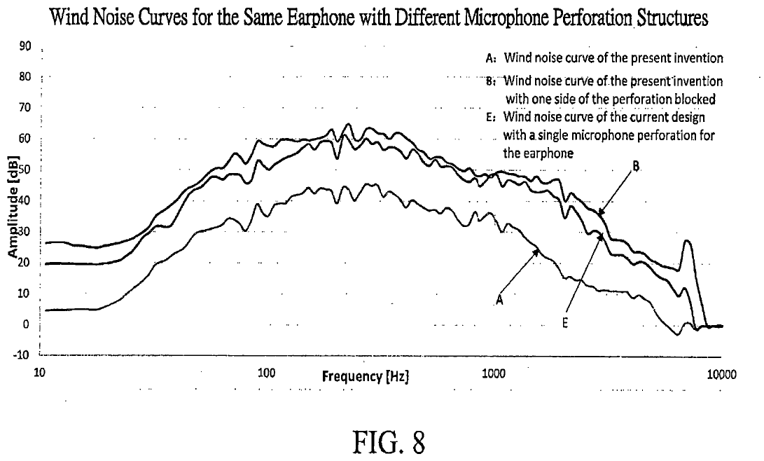

As shown in FIG. 8, this is a wind noise test comparison chart between the invention and other structures in the same earphone. The test products include:
A, an earphone made using the technical solution of the present invention, as shown in FIGS. 2-6;
B, comparative example: a product where one side of the perforation in product A is blocked, i.e., either the left port 301 or the right port 302 is blocked;
E, comparative example: product A with a single microphone hole at the bottom, as shown in FIG. 1.

The comparison test in FIG. 8 is for the same product, testing the wind noise reduction effect of different microphone hole structures. After testing and comparison, the wind noise reduction effect of the present invention is significantly better than that of the comparative examples. In comparative product E, although the earphone used the technical solution of the present invention, it still adopts the single microphone hole design of existing products, and its wind noise reduction effect is noticeably weaker than that of product A, which uses the technical solution of the present invention.

Of course, the above embodiments are only specific examples of the present invention and are not intended to limit the scope of the invention. Any equivalent changes or modifications made according to the structure, characteristics, and principles described in the patent scope of the present invention shall fall within the scope of the present invention.

We claim:

1. A wind noise reduction structure for a wireless Bluetooth earphone, comprising:
an earphone body (1) and a stem (2) connected to the earphone body (1),
wherein a perforation (3) as a microphone hole is provided near a lower end of the stem (2), the perforation (3) penetrates the stem (2), and an opening direction of the perforation (3) intersects with the axial direction of the stem (2), allowing external sound to enter through the perforation (3) and be transmitted to the microphone set within the stem (2).

2. The wind noise reduction structure for a wireless Bluetooth earphone according to claim 1, wherein the perforation (3) comprises:
a left channel (31), a right channel (32), and a connecting chamber (33) located between the left and right channels (31, 32), the left channel (31) and the right channel (32) are connected through the connecting chamber (33).

3. The wind noise reduction structure for a wireless Bluetooth earphone according to claim 2, wherein the connecting chamber (33) has a chamber opening (331) for communicating with the microphone.

4. The wind noise reduction structure for a wireless Bluetooth earphone according to claim 3, wherein a mounting platform (332) for mounting the microphone is formed at the chamber opening (331).

5. The wind noise reduction structure for a wireless Bluetooth earphone according to claim 1, wherein the opening direction of the perforation (3) forms an angle of 70°-90° with the axial direction of the stem (2).

6. The wind noise reduction structure for a wireless Bluetooth earphone according to claim 1, wherein the perforation (3) forms a left port (301) and a right port (302) on the surface of the left and right sides of the stem (2), and the surfaces on the left and right sides of the stem (2) are not parallel.

7. The wind noise reduction structure for a wireless Bluetooth earphone according to claim 6, wherein the surface of the stem (2) has a curved surface (20), and the left port (301) and right port (302) are located on the curved surface (20).

8. The wind noise reduction structure for a wireless Bluetooth earphone according to claim 1, wherein the stem (2) comprises a front stem (21) and a rear stem (22) that are mutually engaged, the earphone body (1) is fixedly connected to the front stem (21) or integrally formed, and the perforation (3) penetrates the front stem (21).

9. A wind noise reduction method for a wireless Bluetooth earphone, the wireless Bluetooth earphone comprising:
an earphone body (1) and a stem (2) connected to the earphone body (1),
the wind noise reduction method comprising:
providing a perforation (3) as a microphone hole near the lower end of the stem (2), penetrating the stem (2),
wherein the perforation (3) has a left port (301) and a right port (302), and by setting the left port (301) and right port (302) at different heights, the method avoids the distortion during microphone sound pickup caused by direct frontal wind blowing into the perforation (3) and reduces the impact of turbulence.

10. The wind noise reduction method for a wireless Bluetooth earphone according to claim 9, wherein the left port (301) and right port (302) are inclined towards the front surface of the stem (2).
